(19) United States
(12) Patent Application Publication
(10) Pub. No.: US 2020/0390208 A1
(43) Pub. Date: Dec. 17, 2020

(54) Linear Action Retractable Wheel Luggage Mechanism

(71) Applicant: PDSS LUGGAGE LLC, Tampa, FL (US)

(72) Inventors: BOBBY SOHAIL SHAH, NEWPORT BEACH, CA (US); PATHMANATH D. DESILVA, TAMPA, FL (US); SAM GARRISON, BEAVERTON, OR (US); WILLIAM CONLEY, LONG BEACH, CA (US); ROGER THOMASON, SANTA MONICA, CA (US)

(21) Appl. No.: 16/606,384

(22) PCT Filed: Jun. 25, 2019
(86) PCT No.: PCT/US19/39016

§ 371 Date: Oct. 18, 2019

Related U.S. Application Data
(60) Provisional application No. 62/791,975, filed on Jan. 14, 2019.
(60) Provisional application No. 62/790,835, filed on Jan. 10, 2019.

(51) Int. Cl. A45C 5/14; B60B 33/06; B60B 33/00; A45C 13/26

(52) U.S. Cl. CPC A45C 5/146; B60B 33/063; B60B 33/0026; A45C 2013/267; B60B 33/0042; B60B 33/0068; B60B 2200/45; A45C 13/262

(57) ABSTRACT

Luggage with retractable wheels is described, specifically pivoting caster wheels. A telescopic handle is provided on the luggage bag which actuates the retractable wheels using a unique linear mechanism. Pushing the telescopic handle down to the stowed position allows the wheels to retract inside the bag, making the bag easier to stow in the restricted storage space available in the passenger cabin of a commercial aircraft Pulling the telescopic handle out into an extended configuration allows the wheels to deploy into an operable position.

### CROSS REFERENCE TO RELATED APPLICATIONS

This application claims priority to U.S. provisional application 62/790,835, Linear Action Retractable Wheel Luggage Mechanism, filed on 10 Jan. 2019, and, U.S. provisional application 62/791,975, Linear Action Retractable Wheel Luggage Mechanism, filed on 14 Jan. 2019, both by the same inventors.

### STATEMENT REGARDING FEDERALLY SPONSORED RESEARCH OR DEVELOPMENT

Not applicable.

### BACKGROUND OF THE INVENTION

### Field of the Invention

This invention relates to luggage having retractable wheels, specifically pivoting caster wheels.

### Related Background Art

This invention relates to luggage with retractable wheels, specifically pivoting caster wheels. A telescopic handle is provided on the luggage bag which actuates the retractable wheels using a unique linear mechanism. Pushing the telescopic handle down to the stowed position allows the wheels to retract inside the bag, making the bag easier to stow in the restricted storage space available in the passenger cabin of a commercial aircraft. Pulling the telescopic handle out into an extended configuration deploys the wheels into an operable position.

Prior art retractable wheels generally pivot on a substantially horizontal axis into the bottom of the bag, or must be manually moved to a stowed position. Pivoting horizontally into a pocket can cause problems in use, since the caster wheels must be oriented correctly to fit into the stowage pockets in the bag. The stowage pockets for horizontally pivoting wheels tend to take up a lot of bag volume. The pivoting mechanisms also tend to be heavy and bulky linkages.

Manually stowing the wheels is inconvenient and can be dirty, though the bulky linkages are eliminated and generally less wheel stowage volume is required in the bag. It would be desirable to provide a retractable wheel mechanism for luggage that is easy to use, takes minimum volume in the bag, and adds minimal weight. Additionally it would be desirable to allow stowage of the wheels at any orientation of the caster assemblies.

### BRIEF SUMMARY OF THE INVENTION

A system is described that addresses the desirable features and prior art deficiencies described above. A unit of luggage with retractable wheels is described. The wheels retract linearly into substantially vertical pockets at the bottom corners of the luggage bag. This reduces the amount of bag storage volume lost to wheel storage volume. The wheel assemblies include standard pivoting casters that allow full “spinner” operation of the bag while the wheels are deployed. The casters are spring loaded inside rotating sleeves that normally latch them into their deployed positions when the telescopic handle is extended. The downward force associated with compressing the telescopic handle compresses the loading spring and forces the wheel assemblies into the retracted configuration wherein the casters are latched by the accompanying rotation of the sleeves which are rotationally coupled to the linear position of the telescopic handle by a Bowden (bicycle) cable. In one embodiment the coupling cable is directly attached to an element of the telescopic handle. In a second embodiment the coupling cable is connected to an intermediate mechanical assembly that attaches to the telescopic handle element and provides mechanical leverage and optimized cable extension.

### BRIEF DESCRIPTION OF THE SEVERAL VIEWS OF THE DRAWINGS

FIG. 1 shows a rear perspective views of an embodiment.

FIG. 2 shows exploded and assembled views of the wheel assembly.

FIG. 3 shows the wheel assemblies in extended and retracted configurations.

FIG. 4 shows a cutaway view of a wheel assembly in the extended configuration.

FIG. 5 shows a cutaway view of a wheel assembly in the retracted configuration.

FIG. 6 shows how the rotating latch sleeve is controlled using a Bowden cable.

FIG. 7 shows an embodiment in which the Bowden cable is directly attached to the telescoping handle structure.

FIG. 8 shows an embodiment in which the Bowden cable is attached to the telescoping handle structure through an intermediate mechanical assembly having a slanted slot.

FIG. 9 shows detail of the embodiment in FIG. 8.

FIG. 10 shows an embodiment in which the Bowden cable is attached to the telescoping handle structure through an intermediate mechanical assembly having a semi-circular slot.

FIG. 11 shows the embodiment of FIG. 10 with the telescoping handle structure in a fully retracted configuration.

FIG. 12 shows the embodiment of FIG. 10 with the telescoping handle structure in an intermediate extended configuration.

FIG. 13 shows alternative configurations of the cylindrical sleeve that produce different locking angles of the wheel assembly.

FIG. 14 shows an alternative modular construction of the suitcase.

### DETAILED DESCRIPTION OF THE INVENTION

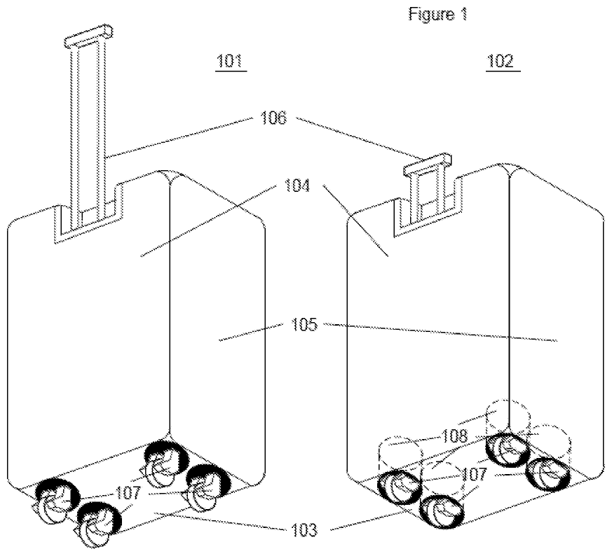

FIG. 1 shows rear perspective views of an embodiment of the invented retractable wheel suitcase in the extended 101 and retracted 102 configurations. The views show the bottom surface 103, the rear side panel 104 and one of the vertical side panels 105. In the extended configuration 101 the telescopic handle 106 is extended to allow convenient control of the luggage while the wheels 107 are latched in their extended positions. In the retracted configuration 102 the telescopic handle 106 is collapsed within the frame of the luggage (not shown) and the wheels 107 are latched into their retracted positions within cylindrical shells 108 built into the frame of the luggage.

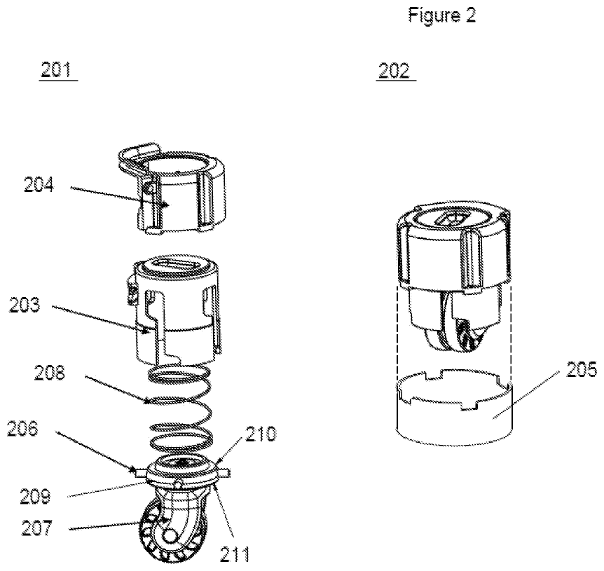

FIG. 2 shows exploded 201 and assembled 202 views of the wheel assembly. Rotating latch sleeve 203 rotates freely within top cover 204 which attaches rigidly to the frame of the luggage and engages with cylindrical bottom cover 205 which is also rigidly attached to the frame. Latch sleeve 203 engages with guide pins 206 attached to and protruding from the periphery 209 of circular disk 210. Wheeled caster 207 is mounted to the lower surface 211 of disk 210. The force applied by deploy cylindrical compression spring 208 and external forces applied to the luggage cause the wheeled caster 207 to move between deployed and retracted positions and the rotation of latch sleeve 203 causes wheeled caster 207 to be securely latched into those positions.

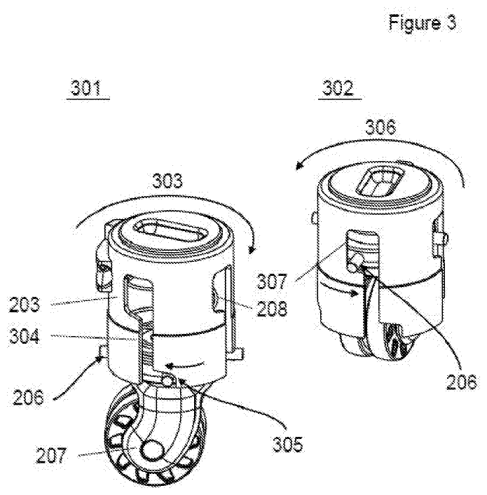

FIG. 3 shows the wheel assemblies in extended 301 and retracted 302 configurations. Clockwise rotation of the latch sleeve 203 and extension of the deploy spring 208 causes the guide pins 206 to lower through axial slot 304 and rotate into lower latch sleeve radial slot 305, thereby effectively latching the wheeled caster 207 in the extended position. Counter-clockwise rotation 306 of latch sleeve 203 and compression of the deploy spring 208 causes the guide pins 206 to raise through axial slot 304 and rotate into upper latch sleeve radial slot 307 thereby effectively latching the wheeled caster 207 in the retracted position. The extended vertical opening of upper latch sleeve ramp 307 allows the caster 207 to tilt within the latch sleeve 203 when in the retracted position, thereby providing a more compact retracted configuration.

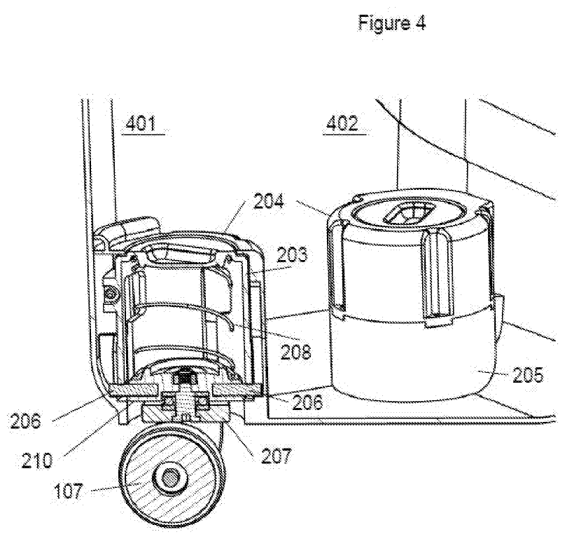

FIG. 4 shows a cross-sectional view 401 of a wheel assembly down and locked in the extended configuration for normal “spinner” bag operation. The wheel 107 is offset from the vertical axis of rotation in the wheeled caster 207 arrangement, as is typical for spinner luggage. Thus the wheel 107 can orient itself properly for the bag moving in any direction.

The wheel assemblies 402 are placed near the corners of the luggage in order to maximize usable space. The height of the cylindrical wheel stowage shells 108 comprising top cover 204 and bottom cover 205 is also kept to a minimum for this purpose. It is important to provide a compact mechanism for keeping the retractable wheel assembly locked in the down position and stowed in the up position.

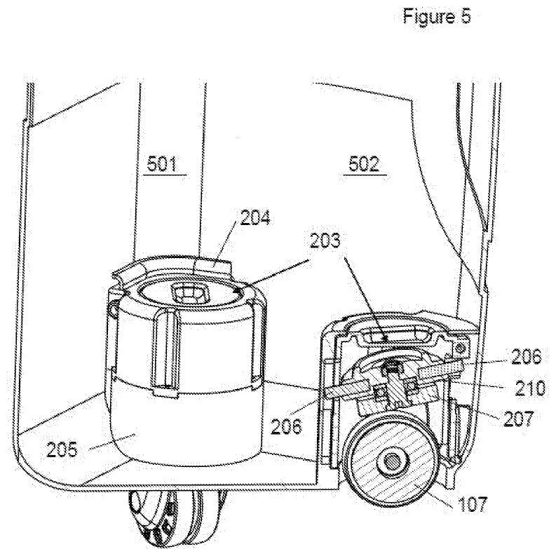

FIG. 5 shows a section view 501 of the wheel assembly in the retracted position. With a caster wheel of this type, a normal stowage shell 108 comprising top cover 204 and bottom cover 205 would have to be quite large to accommodate the caster wheel 107 in any orientation. With this invention, the wheeled caster 207 attached to disk 210 tilts as it moves up into the retracted configuration. This saves substantial bag volume, since the pocket only needs to fit the diameter of wheel 107 with some clearance.

In other embodiments the wheel 107 does not retract all the way into the stowage shell 108. The small part of the wheel sticking out serves as a bag foot. The wheel 107 generally will not rotate in this position since it is tilted against the wall of the stowage shell 108. Thus the bag will not roll away when the wheels are stowed.

Since movement of the wheels between the extended and retracted positions can be accomplished by user operation of the telescoping handle, no heavy linkages are required. In this invention it is only necessary to turn the rotating latch sleeves for each wheel in a coordinated fashion. In the preferred embodiment, this is accomplished with lightweight flexible Bowden (bicycle) cables. These sheathed cables are lightweight, flexible, inexpensive, and durable. They can easily be routed between the wheel assemblies and the telescoping handle actuation mechanism.

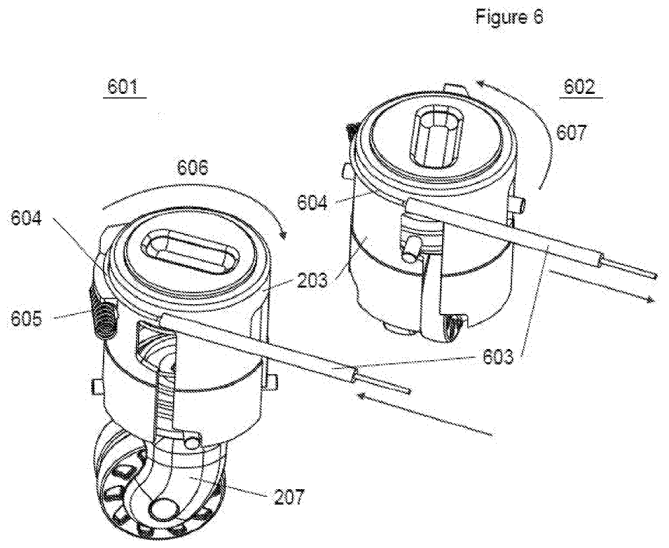

FIG. 6 shows how the position of the rotating latch sleeve 203 in extended 601 and retracted 602 configurations is controlled using a Bowden cable 603. The movable cable 604 within Bowden cable 603 is wrapped partially around the upper portion of the latch sleeve 203 and attached thereto. A separate spring 605 is provided between sleeve 203 and upper cover 204 (not shown) that opposes the tension on the cable 604. Thus, if the tension on cable 604 is relaxed, latch sleeve 203 rotates in a clockwise direction 606 allowing the wheeled caster 207 to emerge and latch in the extended position 601. Applying tension on the cable 604 compresses spring 605 and rotates the latch sleeve 203 in a counter-clockwise direction 607 allowing wheeled caster 207 to be withdrawn and latch into the retracted position 602.

In the wheeled bag of the invention, it is desirable to actuate the latch sleeve of each wheel in a coordinated fashion. It is also desirable to actuate and latch the wheels automatically using a telescoping handle assembly as commonly found on travel luggage.

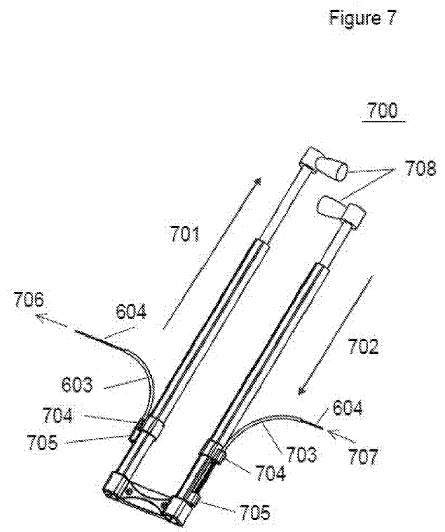

FIG. 7 shows a telescoping handle assembly 700 in which the horizontal grip 708 is split to show extended 701 and retracted 702 operating positions wherein the Bowden inner cable 603 is directly attached to a vertical shaft element of the telescoping handle 700. The outer sheath 703 of Bowden cable 603 is affixed to the frame of the telescoping handle assembly 704 which is attached to the rear surface of the suitcase 104, while the movable inner cable 604 is affixed to the end of a movable element of the telescoping handle 705. Thus, extending 701 the telescoping handle 700 also extends 706 the movable cable 604 while compressing 702 the telescoping handle 700 retracts 707 the movable cable 604.

Although FIG. 7 shows only one Bowden cable attached to each leg of the telescoping handle 700, it will be apparent to one skilled in the art that several Bowden cables can be attached at either leg. In the preferred embodiment, a pair of Bowden cables attached at one leg of the telescoping handle operate the front and rear wheel latches for the corresponding side of the bag, while another pair of Bowden cables attached at the other leg of the handle operate the front and rear wheel latches for the opposite side of the bag. This keeps forces on the handle balanced and optimizes cable packaging in the bag.

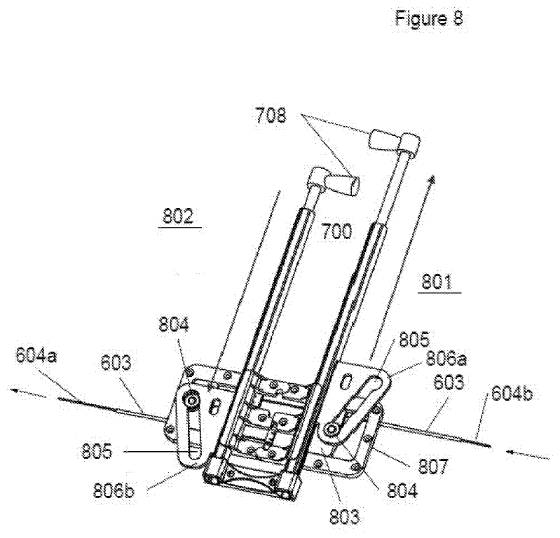

In some embodiments of the invention, it may be desirable to reduce the telescoping handle force required to actuate multiple retracting wheel latches. Usually there is excess telescoping handle travel available relative to the Bowden cable travel needed by the latch sleeves. In FIG. 7, the Bowden cable forces act directly on the handle. FIG. 8 shows an embodiment in which the Bowden cable is attached to the telescoping handle structure through an intermediate mechanical assembly. FIG. 8 shows a telescoping handle assembly 700 in which the horizontal grip 708 is split to show extended 801 and retracted 802 operating positions wherein the Bowden cable 603 is attached to a sliding cable actuator block 803 confined to horizontal motion within frame 807 attached to the rear surface of the suitcase, and driven by an attached roller 804 guided in a slanted slot 805 cut in a bracket 806 attached to an element of the telescoping handle 700. With the telescoping handle 700 in the extended position 801 the bracket 806a moves upward forcing the roller 804 within slot 805 closer to the telescoping handle element thereby extending the movable cable 604a. With the telescoping handle 700 in the retracted position 802 the bracket 806b moves downward forcing the roller 804 attached to sliding cable actuator block 803 and within slot 805 away from the telescoping handle element thereby retracting the movable element 604b.

One or more Bowden cables are attached to each sliding cable actuator block. Movement of the telescoping handle 700 is translated into movement of the Bowden cable(s) with extra mechanical advantage provided by the angled slot 805 in bracket 806. In the preferred embodiment, one leg of the telescoping handle operates the front and rear wheel latches for the corresponding side of the bag, while the other leg of the handle operates the front and rear wheel latches for the opposite side of the bag. This keeps forces on the handle balanced and optimizes cable packaging in the bag.

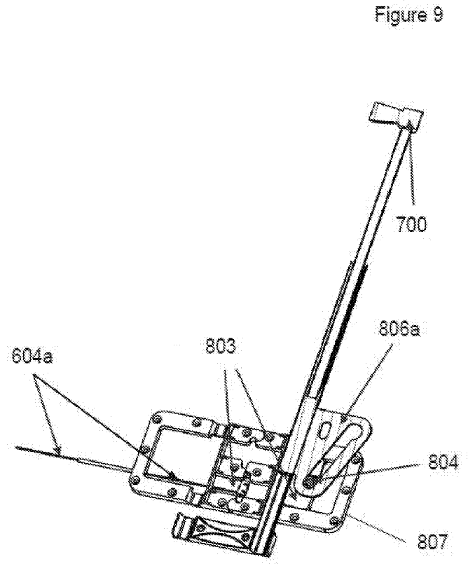

FIG. 9 shows detail of the embodiment in FIG. 8 more clearly illustrating the relationships among the telescoping handle 700, the bracket 806a, roller 804 attached to sliding block 803 within fixed frame 807 and translating movable element 604a.

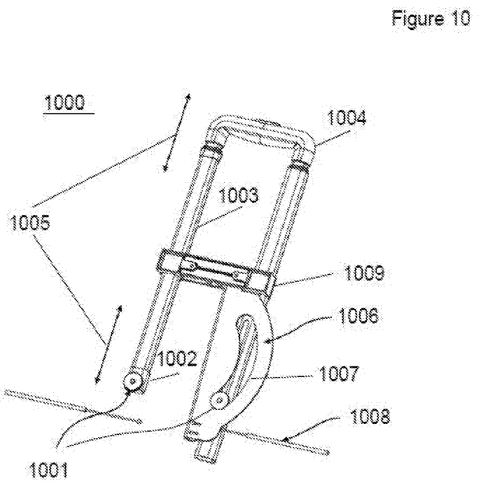

FIG. 10 shows an embodiment of the telescoping handle cable actuation arrangement that employs a different intermediate mechanical assembly 1000. Unlike the mechanism of FIGS. 7-9, rollers 1001 are mounted rotatably to blocks 1002 which are fixed to the tubes 1003 of the telescoping suitcase handle 1004. As the handle 1004 is raised or lowered, the blocks 1002 and rollers 1001 are correspondingly raised or lowered 1005. In FIG. 10, a cable actuator 1006 is shown, which has slot 1007 engaging the translating roller 1001. The upper end of cable actuator 1006 is rotatably attached to frame 1009 which is affixed to the rear surface 104 of the suitcase. The shape of the slot provides optimal movement of a push-pull cable 1008 to actuate the corresponding retractable wheel assembly of the suitcase. The cable actuation mechanism of FIG. 10 also provides packaging, space, and weight advantages over the mechanism shown in FIGS. 7-9.

In some embodiments of the retractable wheel suitcase, it is advantageous to have the actuation cables relax at the top and bottom of handle travel. This removes tension from the cables at all times except while the handle is being moved from one end position to the other. By tensioning the cables in this way, the retractable wheel motion is accomplished only while the handle is in between its two end positions. This saves wear and stress on the cables over the long term.

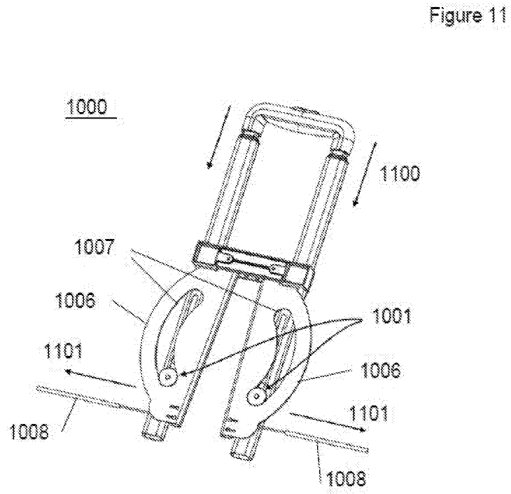

FIG. 11 shows the handle assembly 1000 in the down position 1100. The rollers 1001 and slots 1007 move the lower ends of cable actuators 1006 away from each other 1101, which relaxes the retractable wheel actuation cables 1008.

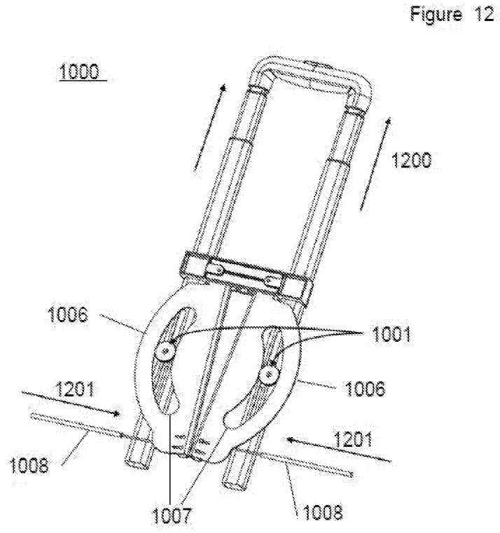

FIG. 12 shows the suitcase handle assembly 1000 in an intermediate position, moving upward 1200. This motion causes the attached rollers 1001 to move to an intermediate position relative to the cable actuator slots 1007 which causes the lower ends of cable actuators 1006 to move towards each other 1201. Note that the same movement occurs if the suitcase handle assembly 1000 is being moved downward from its fully up position. Either movement causes the retractable wheel cables 1008 to tighten, releasing the wheels to move between their full up locked and full down locked positions.

As described earlier, lifting the suitcase handle 1004 upward will generally lighten the load on the retractable wheels. As the handle travels to an intermediate position as in FIG. 12 and the tension on the retractable wheel cables 1008 releases the wheel latches, and springs 208 will push the wheels to their fully deployed position. As the handle completes its movement upward, the tension on the retractable wheel cables 1008 will relax and the wheel latches will engage to lock the wheels in their deployed position. Likewise, pushing the handle downward will generally increase the load on the wheels. In mid-travel, the cables will tighten and release the wheel latches. The increased wheel load will overcome the springs and push the wheels into their retracted positions. As the handle completes its downward motion, the tension on the retractable wheel cables 1008 will relax and the wheel latches will engage to lock the wheels in their retracted position.

In some embodiments of the retractable wheel suitcase, it may be desirable to provide a wheel force overload retract function that could act as a shock absorber to cushion the suitcase structure if dropped onto fully extended wheels. The overload retract function would allow one or more wheels to temporarily unlatch and retract against their springs during impact. Once the impact force subsides, the wheel spring pushes the wheel back down into the latched extended position.

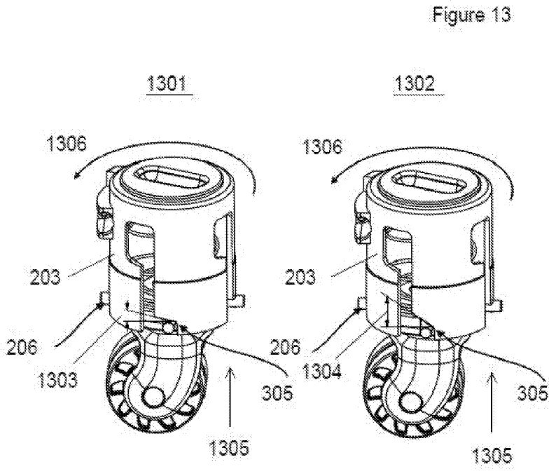

The overload force at which the extended wheel retracts is a function of the locking angle of the lower radial slot 305 in the latch sleeve 203 against the guide pins 206. The rotary latch sleeve 203 must rotate under the force applied by the guide pins 206 to free the guide pins 206 into an unlatched position. FIG. 13 shows two versions of extended wheel assemblies 301 illustrated earlier in FIG. 3. Version 1301 shows a wheel assembly having a shallow locking angle 1303 while version 1302 shows a wheel assembly having a larger locking angle 1304. A shallow locking angle as in 1301 provides a high latching force, making it difficult for a vertical wheel impact force 1305 to rotate 1306 the latch sleeve 203. If the locking angle is increased as in 1302 a steeper wedge is created which makes it easier for the wheel impact force 1305 to rotate 1306 the latch sleeve 203.

The ideal locking angle is dependent upon the pin and sleeve material coefficient of friction, as well as the desired wheel force to release the latch. Ideally this would be determined through testing with samples of the preferred embodiment.

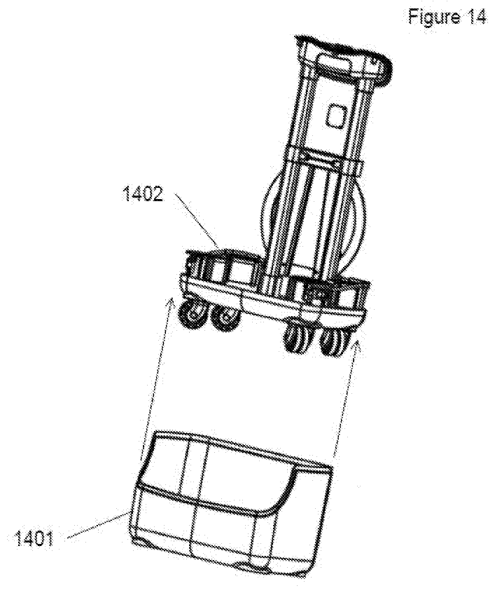

In some embodiments of the invention, it may be desirable to provide a modular assembly including an independent mechanical structure to support the retractable wheel assembly, while providing a suitcase shell of a different material. This could be done for cosmetic or economic reasons, or to provide impact resistance advantages. FIG. 14 shows a preferred embodiment of the alternative construction using outer shell 1401 and a separate retractable wheel structure 1402 using the mechanism of FIGS. 10-12.

### SUMMARY

A unit of luggage with retractable wheels is described. The wheels retract linearly into substantially vertical pockets at the bottom corners of the luggage bag. This reduces the amount of bag storage volume lost to wheel storage volume. The wheel assemblies include standard pivoting casters that allow full “spinner” operation of the bag while the wheels are deployed. The casters are spring loaded inside rotating sleeves that normally latch them into their deployed positions when the telescopic handle is extended. The downward force associated with compressing the telescopic handle compresses the loading spring and forces the wheel assemblies into the retracted configuration wherein the casters are latched by the accompanying rotation of the sleeves which are rotationally coupled to the linear position of the telescopic handle by a Bowden (bicycle) cable. In one embodiment the coupling cable is directly attached to an element of the telescopic handle. In a second embodiment the coupling cable is connected to an intermediate mechanical assembly that attaches to the telescopic handle element and provides mechanical leverage and optimized cable extension.

Those skilled in the art will appreciate that various adaptations and modifications of the preferred embodiments can be configured without departing from the scope and spirit of the invention.

Therefore, it is to be understood that the invention may be practiced other than as specifically described herein, within the scope of the appended claims.

1) A mechanism for raising and lowering a wheeled caster, the mechanism comprising:
a) a circular disk, said disk having a diameter, an upper surface, and a lower surface, and, a periphery, the wheeled caster attached to the lower surface of the circular disk, and, at least three guide pins each having a diameter, attached to, positioned on, and protruding outward from the periphery of the circular disk, and,
b) a cylindrical sleeve having a closed top with an upper surface and a lower surface, and an open bottom and having a diameter sized to admit the circular disk and the attached wheeled caster, and, having a height sufficient to fully enclose the circular disk and the attached wheeled caster, and, further incorporating a plurality of axial slots located and sized to admit the diameter of the guide pins on the circular disk, and, spaced according to the placement of the guide pins on the periphery of the circular disk and further incorporating opposing radial slots communicating with said axial slots and located near the top of the cylindrical sleeve and at its bottom and sized to admit the guide pins on the periphery of the circular disk and inhibit rotation of the circular disk, and,
c) a cylindrical compression spring operably placed within the cylindrical sleeve between the lower surface of its closed top and the upper surface of the circular disk, said spring having an uncompressed length at least equal to the height of the cylindrical sleeve, and,
d) a cylindrical top cover having a closed top and having a height and having a diameter sized to admit the diameter of the cylindrical sleeve, and
e) a cylindrical bottom cover having a height and having a diameter equal to the diameter of the top cover and further having a bottom surface with a centered hole having a diameter sufficient to admit the wheeled caster, wherein the height of the top cover and bottom cover are sufficient to fully enclose the cylindrical sleeve and mate to form a cover assembly that can be rigidly attached to a mounting frame, and
f) a Bowden cable attached to the cylindrical sleeve such that the cylindrical sleeve is rotated with respect to the cover assembly upon tensioning of the Bowden cable.

2) A suitcase with retractable wheels, the suitcase having a front surface, a back surface, a top surface, a bottom surface and two side surfaces and further comprising:
a) a telescoping handle comprising a horizontal grip and at least one telescoping vertical shaft, said shaft having at least a top section and a bottom section wherein the top section is attached to said grip and the bottom section is attached to the back surface of the suitcase wherein the telescoping vertical shaft can be extended and retracted vertically, and,
b) at least two Bowden cables each having a first end and a second end and each further comprising an inner cable and an outer sheath wherein the outer sheath of the first end is attached to the back surface of the suitcase and the inner cable of the first end is attached to the top section of the telescoping shaft in such a way that extending the telescoping shaft also extends the inner cable of the Bowden cable, and,
c) at least two mechanisms as described in claim 1 each rigidly attached to the back surface of the suitcase adjacent to each side surface and each attached to the second end of the inner cable of one of the Bowden cables.

3) A suitcase with retractable wheels, the suitcase having a front surface, a back surface, a top surface, a bottom surface and two side surfaces and further comprising:
a) a telescoping handle comprising a horizontal grip and at least one telescoping vertical shaft, said shaft having at least a top section and a bottom section wherein the top section is attached to said grip and the bottom section is attached to the back surface of the suitcase wherein the telescoping vertical shaft can be extended and retracted vertically, and,
b) a mechanical assembly attached to the bottom section of the telescoping vertical shaft and comprising a movable bracket attached to the top section of the telescoping vertical shaft and having a slanted slot within which travels a roller fixedly attached to a movable block, said movable block confined to horizontal movement within a plane parallel to the back surface of the suitcase whereby vertical motion of the telescoping shaft is transferred into horizontal motion of the movable block, and,
c) at least two Bowden cables each having a first end and a second end and each further comprising an inner cable and an outer sheath wherein the outer sheath of the first end is attached to the back surface of the suitcase and the inner cable of the first end is attached to the movable block in the mechanical assembly attached to the bottom section of the telescoping vertical shaft in such a way that extending the telescoping shaft also extends the inner cable of the Bowden cable, and,
d) at least two mechanisms as described in claim 1 each rigidly attached to the back surface of the suitcase adjacent to each side surface and each attached to the second end of the inner cable of one of the Bowden cables.

4) A suitcase with retractable wheels, the suitcase having a front surface, a back surface, a top surface, a bottom surface and two side surfaces and further comprising:
a) a telescoping handle comprising a horizontal grip and at least one telescoping vertical shaft, said shaft having at least a top section and a bottom section wherein the top section is attached to said grip and the bottom section is attached to the back surface of the suitcase wherein the telescoping vertical shaft can be extended and retracted vertically, and,
b) a mechanical assembly attached to the bottom section of the telescoping vertical shaft and comprising a movable bracket having a top and a bottom wherein the top is rotatably attached to the bottom section of the telescoping vertical shaft, said bracket having a semicircular slot within which travels a roller fixedly attached to the top section of the telescoping vertical shaft, wherein the bottom of the movable bracket is confined to movement within a plane parallel to the back surface of the suitcase whereby vertical motion of the telescoping shaft is transferred into horizontal motion of the bottom of the movable bracket, and,
c) at least two Bowden cables each having a first end and a second end and each further comprising an inner cable and an outer sheath wherein the outer sheath of the first end is attached to the back surface of the suitcase and the inner cable of the first end is attached to the bottom of the movable bracket in the mechanical assembly attached to the bottom section of the telescoping vertical shaft in such a way that extending the telescoping shaft also extends the inner cable of the Bowden cable, and,
d) at least two mechanisms as described in claim 1 each rigidly attached to the back surface of the suitcase adjacent to each side surface and each attached to the second end of the inner cable of one of the Bowden cables.

5) The mechanism of claim 1 wherein the radial slots located at the bottom of the cylindrical sleeve have an upper edge slanted with respect to a plane perpendicular to the axial slots in the cylindrical sleeve so as to allow the guide pins to slide into the axial slots in the cylindrical sleeve when a vertical force is applied to them.

6) The suitcase of claim 2 wherein the telescoping handle, mechanical assembly, Bowden cables, and wheeled caster raising and lowering mechanisms are assembled into an independent mechanical assembly, and the front, back top, bottom and side surfaces comprise a separate shell attached to and fully covering the independent mechanical assembly.

7) The suitcase of claim 3 wherein the telescoping handle, mechanical assembly, Bowden cables, and wheeled caster raising and lowering mechanisms are assembled into an independent mechanical assembly, and the front, back top, bottom and side surfaces comprise a separate shell attached to and fully covering the independent mechanical assembly.

8) The suitcase of claim 4 wherein the telescoping handle, mechanical assembly, Bowden cables, and wheeled caster raising and lowering mechanisms are assembled into an independent mechanical assembly, and the front, back top, bottom and side surfaces comprise a separate shell attached to and fully covering the independent mechanical assembly.
